(19) United States
(12) Patent Application Publication
(10) Pub. No.: US 2026/0178015 A1
(43) Pub. Date: Jun. 25, 2026

(54) METHOD AND SYSTEM TO ALLOCATE PHYSICAL FEED ACCORDING TO OPTIMIZATION THAT INCLUDES DIGITAL CREDITS

(71) Applicant: ExxonMobil Technology and Engineering Company, Spring, TX (US)

(72) Inventors: Youngdae KIM, Hillsborough, NJ (US); Trent J. OKESON, Spring, TX (US); Dimitri J. PAPAGEORGIOU, Stewartsville, NJ (US); Benjamin F. SAUK, Conroe, TX (US); Yu ZHU, Sugar Land, TX (US)

(21) Appl. No.: 19/392,693

(22) Filed: Nov. 18, 2025

Related U.S. Application Data
(60) Provisional application No. 63/736,450, filed on Dec. 19, 2024.

(51) Int. Cl. G05B 19/418

(52) U.S. Cl. CPC G05B 19/41865

(57) ABSTRACT

A methodology for allocating physical feeds is provided. The method includes receiving a physical feed, digital feed, and digital credits. The method also includes jointly calculating an optimal allocation of both the physical and digital feeds to maximize a value of both physical and digital products. The method also further includes adjusting a physical feed allocation in a plant based on the maximized value to generate a finished physical product.

### CROSS-REFERENCE TO RELATED APPLICATION

This application claims the benefit of U.S. Provisional Application Ser. No. 63/736,450, entitled “METHOD AND SYSTEM TO ALLOCATE PHYSICAL FEED ACCORDING TO OPTIMIZATION THAT INCLUDES DIGITAL CREDITS,” filed Dec. 19, 2024, the disclosure of which is hereby incorporated by reference in its entirety.

### FIELD OF THE INVENTION

The present application relates generally to the field of hydrocarbon refining. Specifically, the disclosure relates to a methodology for planning and scheduling of refinery feedstock selection and final product generation, such as the selection of biofuel feedstocks and biofuel and production of biofuel mixtures.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Blending and pooling problems have a long history within oil and gas refining applications. Pooling problems seek to find a minimum cost (equivalently, a maximum profit) blend schedule of raw materials to produce finished products that meet quality criteria, demand volume requirements, storage tank capacity limits, and network flow limits. Pooling problems find many industrial applications such as multiperiod blend scheduling of crude oil, lithium recovery from produced water and wastewater network design. Many variants exist including game-theoretic pooling applications with perfect and imperfect competition. In the oil and gas industry, it is estimated that optimally solving pooling problems can lead to multimillion dollar benefits per year.

Many pooling problem applications have historically involved fossil fuel-based raw materials or their derivative products. To promote a transition toward low-carbon energy sources, many governments are imposing regulations on the fuel sources in transportation while simultaneously providing incentives to encourage the use of greener energy sources in the form of sustainability credits. For example, in the United States, blenders can collect renewable identification numbers (RINs) obtained from blending renewable energy sources and sell them to obligated parties, such as refiners and importers of gasoline and diesel, which can in turn be used to meet the renewable volume obligation imposed on those obligated parties. In the European Union's Renewable Energy Directive (RED II), sustainable raw materials can be associated with sustainability credits in the form of a proof of sustainability and their greenhouse gas (GHG) emissions savings characteristics, and these credits can be propagated and attached to finished products to add more value to them. The values created by these credits, together with regulations enforcing the use of certain sustainability credits, can significantly change decisions in finding optimal blend schedules.

### SUMMARY OF THE INVENTION

In one or some embodiments, a method for allocating physical feeds is disclosed. The method includes receiving a physical feed, digital feed, and digital credits. An optimal allocation of both the physical and digital feeds is jointly calculated to maximize a value of both physical and digital products. A physical feed allocation in a plant is adjusted based on the maximized value to generate a finished physical product.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a process flow diagram of an exemplary system for multiperiod blending with digital credits, in accordance with the present techniques;

FIG. 2 is a diagram depicting an example separated blending of a physical feed and associated digital feed to produce physical and digital products, in accordance with the present techniques;

FIG. 3 is an example method for multiperiod blending that includes digital credits, in accordance with the present techniques;

FIG. 4 is a block diagram of an exemplary cluster computing system that may be utilized to implement the present techniques; and

FIG. 5 is a block diagram of an exemplary non-transitory, computer-readable storage medium that may be used for the storage of data and modules of program instructions for implementing the present techniques.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “biofuel” refers to any fuel that is derived from biomass. For example, biofuel may be derived from plant material, algae material, or animal waste.

As used herein, the term “demand credit” refers to a credit associated with a finished biofuel blended product. Demand credits may be sold, traded or delivered to a government to satisfy regulatory biofuel blending obligations.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “fatty acid methyl ester” (“FAME”) as used herein refers to a biofuel produced by transesterification of vegetable oils. FAME is produced by transesterifying vegetable oils with methanol. FAME has similar properties to fossil diesel fuel, and can be used in diesel vehicles or added to diesel fuel. FAME has a lower viscosity than untreated vegetable oil, and a higher lubricity than fossil diesel fuel.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “supply credit” as used herein refers to a credit or certificate associated with the raw biofuel feedstocks. Supply credits may represent the original hydrocarbon source associated with the production of the feedstock. Supply credits are used to ensure that produced demand credits follow specific rules of a particular jurisdiction.

If there is any conflict in the usages of a word or term in this specification and one or more patent or other documents that may be incorporated herein by reference, the definitions that are consistent with this specification should be adopted for the purposes of understanding this disclosure.

### Overview

As described above, values created by digital credits such as sustainability credits can significantly affect optimal blending schedules of physical raw materials. Therefore, it is important to correctly formulate and incorporate sustainability credits in pooling problems.

Blending and pooling problems have a long history within oil and gas refining applications. While several mathematical optimization models have been developed to consider blending problems with emissions-related requirements, these models do not address blending and pooling problems with digital credits, such as those associated with sustainability credits. While some academic papers may mention sustainability and blending, they do not explicitly treat proof of sustainability credits.

Multiperiod blending is used in the planning and scheduling of refinery feedstock selection and final product generation. In particular, limited tankage, time-dependent availability of crudes/streams, uncertain unit operations and product prices force refiners to change plans and schedules over time. A number of layers may therefore be used to optimize processes over different time spans. For example, these layers may include a planning layer, a scheduling layer, and a real-time optimization (RTO) and control (RTC) layer. The planning layer may determine which products and intermediate materials to produce and how to produce them. The scope of the planning layer may be over a particular manufacturing site or multiple manufacturing sites, and the time span may be over a period of weeks. The scheduling layer may include a daily schedule of operations. The scheduling layer may keep track of raw material arrivals, shipment, and inventories. The time span of the scheduling layer may be over a period of days. The RTO layer may include an optimization of operational decisions. For example, the scope of the RTO layer may typically cover a single process area and involve detailed process models. The time span covered by the RTO layer may be a period of hours or minutes. An example multi-period blending problem may receive a particular network, initial conditions, flow profit/costs, supply tank flow and concentration, and demand tank flow and concentration limits. For example, the network may include a number of supply tanks containing raw materials that are coupled to an intermediate set of blending tanks, which are coupled to a number of demand tanks holding finished products. Given the assumptions that supply concentrations are constant, no simultaneous input/output to blending tanks, and perfect mixing, current tools may be used to determine the flows between tanks at each time period, inventories/concentrations for tanks in each period, and a maximum total profit of the overall blending operation. However, while current tools regularly handle blending physical components, these tools may not include the capability of handling non-physical components, such as the proofs of sustainability that arise in biofuel blending.

Accordingly, the present techniques solve these problems by providing techniques for finding optimal solutions to blending and pooling problems that also take into account digital credits, such as those associated with sustainability credits associated with raw materials meant to encourage the use of more environmentally-friendly and sustainable energy sources.

The present techniques may derive one or more benefits. First, the present techniques enable sustainability credits to be incorporated into pooling problems. In particular, the present techniques enable incorporation of sustainability credits without the explicit formulation of specific regulations into the existing pooling problem for physical components. In addition, the techniques allow for a separation of sustainability credits from physical blending, facilitating the application of many existing solution methods for the traditional pooling problems to pooling problems with sustainability credits.

### Multiperiod Blending Techniques

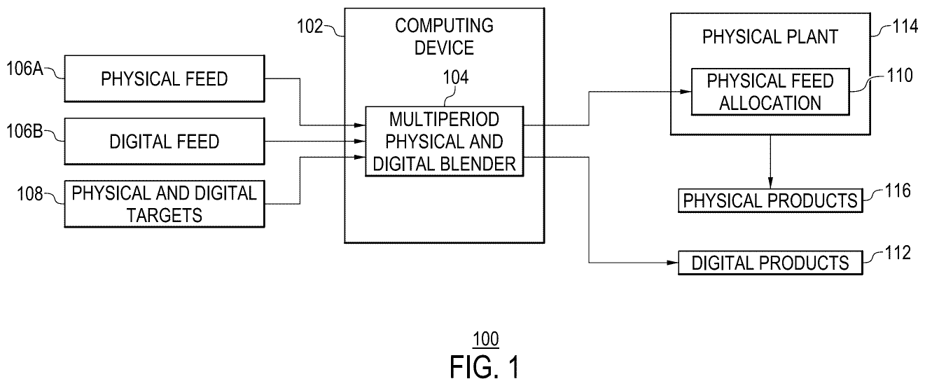

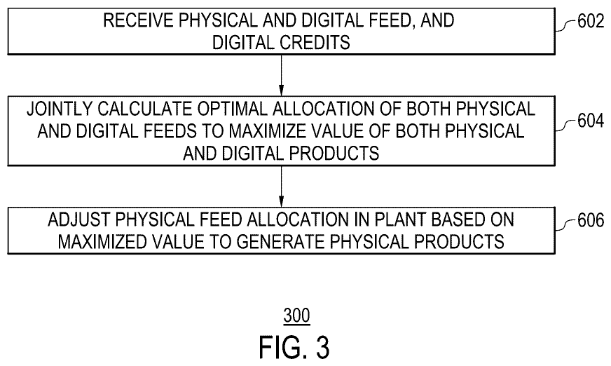

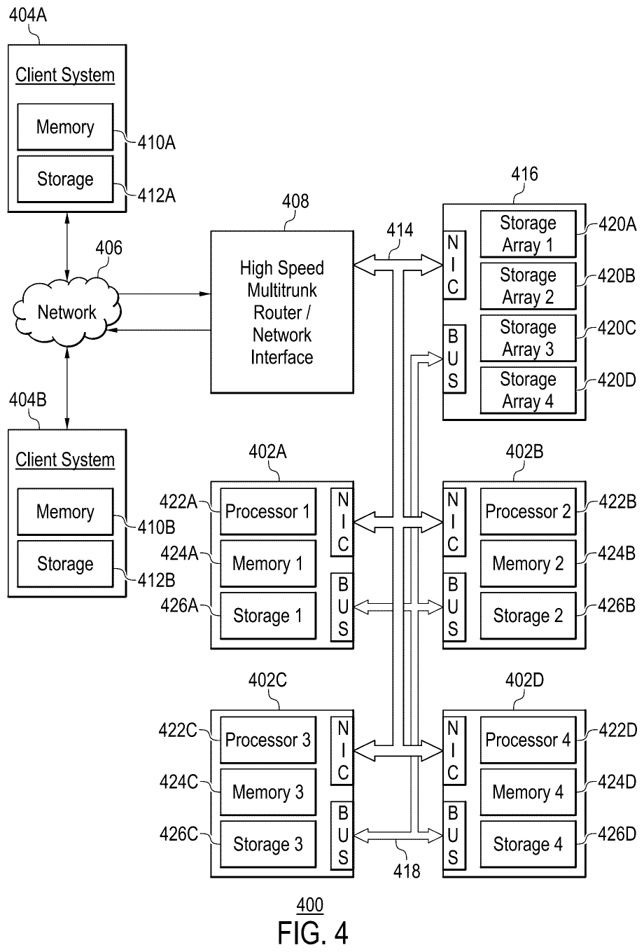

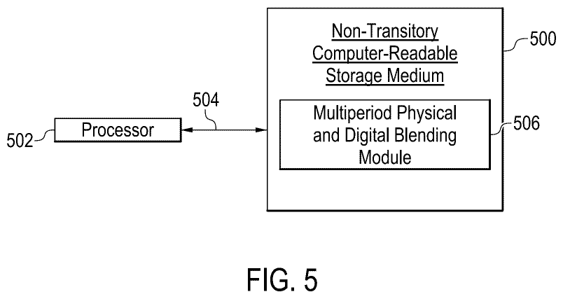

FIG. 1 is a process flow diagram of an exemplary system for multiperiod blending with digital credits, in accordance with the present techniques. For example, the system may be implemented using the methods 300 of FIG. 3. The system 100 includes a computing device 102. For example, the computing device may include a processor, such as of the processors described in FIGS. 4 and 5. The computing device 102 includes a multiperiod physical and digital blender 104.

The system 100 includes a physical and digital feed 106. In various examples, the physical feed 106A and digital feed 106B may be a set of physical raw materials and their associated digital credits. For example, the digital credits may be sustainability credits. Sustainability credits can take different forms depending on the applications and raw materials. In most cases, they follow the mass balance approach. Therefore, in various embodiments, the mass balance approach is used to formulate and incorporate them in pooling problems. In various examples, because of technical difficulties in tracking sustainable raw materials in the blending process, it may be impossible to exactly account for the chemical composition of finished products. Instead of accounting for sustainable materials in every step of the blending process, the mass balance approach allows for sustainable characteristics to be virtually allocated to finished products in the form of sustainability credits, as long as the ratio of sustainable raw materials to non-sustainable ones matches at the boundary of the entire blending process. In other words, individual chemical composition of some finished products may not satisfy the ratio, but the entire composition of all finished products should satisfy the ratio. The mass balance approach enables the techniques herein to separate sustainability credits from physical blending process, which further enables taking advantage of existing efficient solution methods for traditional pooling problems.

The system includes a set of physical and digital targets 108. For example, the physical targets may be a set of products to be produced. In some examples, the products may be various blends of different oils, metals, etc. The digital targets may be digital credits associated with the physical products to be produced. As one example, the physical and digital targets 108 may be various biofuels and a set of sustainability goals to be generated and met by mixing potentially different combinations of the physical feed 106A and the digital feed 106B.

As shown in FIG. 1, the multiperiod physical and digital blender 104 receives input physical feed 106A, digital feed 106B and physical and digital targets 108, and generates a physical feed allocation 110 and digital products 112. The physical feed allocation 110 is sent to the physical plant 114. For example, the physical plant 114 may be an oil or gas refinery. As one example, the physical plant 114 may be a biodiesel blending plant. The physical plant 114 may then product physical products 116 that correspond to the digital products 112. In various embodiments, the digital products 112 are products of a combination of the digital feed that is dissociable from the physical feed.

In various embodiments, one or more components of the physical feed 106A and/or the digital feed 106B may be dynamically adjusted based on updated physical and digital targets 108. For example, an optimization process dynamically adjusts the proportions of different input feeds 106A and 106B based on changing costs and demand over time. This means that the blend composition can vary from one period to the next to take advantage of lower-cost inputs or to meet fluctuating demand or changing regulations in terms of the value of credits such as sustainability credits. In various embodiments, the primary goal of optimization at the multiperiod physical and digital blender 104 is to maximize the overall value of the blending process. For example, such maximization may include minimization of costs, such as selecting the most cost-effective combination of input feeds while ensuring that the final product meets all required specifications, as well as ensuring that regulations enforced using digital credits are met with minimal cost. In various embodiments, digital credits, such as sustainability credits, received in the digital feed 106B influence and thus may alter the input selection decisions of the multiperiod physical and digital blender 104. Moreover, these input selection decisions involve dynamic adjustment. In other words, sustainability credits affect how physical inputs over time are valued, which can lead to different physical blends at different points in time. The multiperiod physical and digital blender 104 can also ensure demand satisfaction. For example, the optimization ensures that the blended product meets the demand for each period. In various examples, this involves forecasting demand and adjusting the blend accordingly to avoid shortages or excess production. In various examples, the multiperiod physical and digital blender 104 may also receive operational constraints. For example, the process must also consider various operational constraints, such as inventory levels, production capacities, and quality specifications. These constraints ensure that the blending process is feasible and efficient. In various embodiments, the different physical blends to be prepared, output by the multiperiod physical and digital blender 104, thus adhere to these operational constraints, in which quality specifications possibly drive different physical decisions. The multiperiod physical and digital blender 104 thus continually determines updated solutions to a pooling problem in which physical and digital values are entangled in a complex web, in which physical feeds may be blended differently when digital credits such as sustainability credits are considered in the global optimization problem.

In some embodiments, the pooling problem with sustainability credits can, in general, be formulated as a mixed integer nonlinear programming problem (MINLP). This formulation involves complex mathematical models that account for the nonlinear relationships between input feeds, costs, and product specifications. For example, a source-based formulation may b used. The nonlinearity originates mainly from capturing the physical blending operations at pools (intermediate tanks) in terms of bilinear terms that enable the tracking qualities of intermediate products. The mixed integer variables are used for modeling operational constraints such as no simultaneous charging and discharging of flows at pools. For sustainability credits, the techniques herein may use a separate layer of linear variables and constraints, where credits can be virtually blended and allocated to final products. Because of the mass balance approach, this separate layer is loosely coupled with physical blending process and does not add any nonlinearity to the problem.

Alternatively, in various embodiments, P, Q, PQ, source-based (SB), or any other suitable formulation for physical pooling/blending problems may be used. In a P-formulation, the problem may be modeled by directly considering the flow rates of the input streams and the quality attributes of the pools (intermediate blending points) and final products. In a Q-formulation, the quality decision variables found in the P-formulation are replaced with variables representing the proportions of flows coming from different supply sources. In a PQ-formulation, both quality and flow proportion variables are used in the model, potentially providing a more compact and often tighter formulation. In an SB formulation, split fractions are used to represent source inputs at pooling nodes. These formulations are conceptually equivalent in that an optimal solution to one formulation can be translated into an optimal solution in another formulation. Some formulations represent the key decisions as a disaggregated/individual component flow from tank i to tank j of component c in time period t. Other formulations track the total flow (summed over all components) from tank i to tank j in time period t, and then use a separate decision variable to track the proportion of total flow from tank i to tank j that is assigned to component c in time period t. Some formulations may have favorable computational characteristics for particular problems. For example, the second approach above in which “total flow” and “proportion” are tracked gives rise to formulations with a tighter/smaller relaxed feasible region. However, this tightness does not necessarily imply that it is a superior formulation in all cases.

Preferably, in various embodiments, the pooling problem is formulated as a generalized disjunctive programming (GDP) formulation. A GDP formulation is preferable to a MINLP formulation because the GDP formulation avoids confusion about big-M values. For example, a GPD formulation may be described using Equations:

$$maximize {\sum }_{t ∈ T} [ {\sum }_{d ∈ D} {β}_{dt} {D}_{dt} + {\sum }_{{r}^{′} ∈ {R}^{′}} {γ}_{{r}^{′} t} {D}_{{r}^{′} t} - {\sum }_{s ∈ S , γ ∈ R} {β}_{s γ t} {S}_{s γ t} ] - {\sum }_{t ∈ T} [ {\sum }_{n , {n}^{′} ∈ A} ( {α}_{n {n}^{′}} {X}_{n {n}^{′} t} + {δ}_{n {n}^{′}} {F}_{n {n}^{′} t} ) + {\sum }_{n ∈ N} {n}_{n} {I}_{nt} ] \qquad Eq . 1 a$$

$$subject to :$$

$${I}_{rt} = {I}_{rt - 1} + {S}_{rt} - {\sum }_{( r , {r}^{′} ) ∈ {A}^{credit}} {F}_{r {r}^{′} t} ∀ r ∈ R , t ∈ T \qquad Eq . 1 b$$

$${S}_{rt} = {\sum }_{s ∈ S} {S}_{srt} ∀ r ∈ R , t ∈ T \qquad Eq . 1 c$$

$${S}_{st} = {\sum }_{r ∈ R} {S}_{srt} ∀ s ∈ S , t ∈ T \qquad Eq . 1 d$$

$${D}_{{r}^{′} t} = {\sum }_{( r , {r}^{′} ) ∈ {A}^{credit}} {F}_{{rr}^{′} t} ∀ {r}^{′} ∈ {R}^{′} , t ∈ T \qquad Eq . 1 e$$

$${D}_{{r}^{′} t} = {\sum }_{d ∈ D : ( d , {r}^{′} ) ∈ M} {D}_{{dr}^{′} t} ∀ {r}^{′} ∈ {R}^{′} , t ∈ T \qquad Eq . 1 f$$

$${D}_{dt} = {\sum }_{{r}^{′} ∈ {R}^{′} : ( d , {r}^{′} ) ∈ M} {D}_{{dr}^{′} t} ∀ d ∈ D , t ∈ T \qquad Eq . 1 g$$

$${C}_{{cr}^{′} t} = {\sum }_{( r , {r}^{′} ) ∈ {A}^{credi}} {C}_{cr}^{IN} {F}_{{rr}^{′} t} ∀ c ∈ C , {r}^{′} ∈ {R}^{′} , t ∈ T \qquad Eq . 1 h$$

$${C}_{{cr}^{′}}^{L} = {\sum }_{( r , {r}^{′} ) ∈ {A}^{credi}} {F}_{{rr}^{′} t} \leq {C}_{{cr}^{′} t} \leq {C}_{{cr}^{′}}^{U} {\sum }_{( r , {r}^{′} ) ∈ {A}^{credi}} {F}_{{rr}^{′} t} , \qquad Eq . 1 i$$

$$∀ c ∈ C , {r}^{′} ∈ {R}^{′} , t ∈ T$$

$${I}_{st} = {I}_{st - 1} + {S}_{st} - {\sum }_{( s , n ) ∈ A} {F}_{snt} ∀ s ∈ S , t ∈ T \qquad Eq . 1 j$$

$${I}_{dt} = {I}_{dt - 1} + {\sum }_{( n , d ) ∈ A} {F}_{ndt} - {D}_{dt} ∀ d ∈ D , t ∈ T \qquad Eq . 1 k$$

$$[ \begin{matrix}{X}_{nbt} \\ {F}_{nb}^{L} \leq {F}_{nbt} \leq {F}_{nb}^{U}\end{matrix} ] ∨ [ \begin{matrix}¬ {X}_{nbt} \\ {F}_{nbt} = 0\end{matrix} ] ∀ ( n , d ) ∈ A , t ∈ T \qquad Eq . 2 l$$

$$[ \begin{matrix}{X}_{sdt} \\ {F}_{sd}^{L} \leq {F}_{sdt} \leq {F}_{sd}^{U} \\ {Q}_{qd}^{L} \leq {Q}_{qs}^{IN} \leq {Q}_{qd}^{U} ∀ q ∈ Q\end{matrix} ] ∨ [ \begin{matrix}¬ {X}_{sdt} \\ {F}_{sdt} = 0\end{matrix} ] ∀ ( s , d ) ∈ A , t ∈ T \qquad Eq . 2 m$$

$$[ \begin{matrix}{X}_{bdt} \\ {F}_{bd}^{L} \leq {F}_{bdt} ⩽ {F}_{bd}^{U} \\ {Q}_{qd}^{L} \leq {Q}_{qbt - 1} \leq {Q}_{qd}^{U} ∀ q ∈ Q\end{matrix} ] ∨ [ \begin{matrix}¬ {X}_{bdt} \\ {F}_{bdt} = 0\end{matrix} ] ∀ ( b , d ) ∈ A , t ∈ T \qquad Eq . 2 n$$

$$[ \begin{matrix}{Y}_{bt} \\ {I}_{bt} = {I}_{b - 1} + {\sum }_{( n , b ) ∈ A} {F}_{nbt} \\ {I}_{bt} {Q}_{bt} = {I}_{bt - 1} {Q}_{bt - 1} + {\sum }_{( s , b ) ∈ A} {F}_{sbt} {Q}_{qs}^{IN} + \\ {\sum }_{( {b}^{′} , b ) ∈ A} {F}_{{b}^{′} bt} {Q}_{{qb}^{′} t - 1} ∀ q ∈ Q\end{matrix} ] ∨ [ \begin{matrix}¬ {X}_{bbt} \\ {F}_{bdt} = 0\end{matrix} ] \qquad Eq . 2 o$$

$$∀ ( b , d ) ∈ A , t ∈ T$$

$${X}_{nbt} ⇒ {Y}_{bt} ∀ ( n , b ) ∈ A , t ∈ T \qquad Eq . 2 p$$

$${X}_{bnt} ⇒ ¬ {Y}_{bt} ∀ ( b , n ) ∈ A , t ∈ T \qquad Eq . 2 q$$

$${I}_{n}^{L} \leq {I}_{nt} \leq {I}_{n}^{U} ∀ n ∈ N , t ∈ T \qquad Eq . 2 r$$

$${F}_{{nn}^{′}}^{L} \leq {F}_{{nn}^{′} t} \leq {F}_{{nn}^{′}}^{U} ∀ ( n , {n}^{′} ) ∈ A , t ∈ T \qquad Eq . 2 s$$

$${Q}_{q}^{L} \leq {Q}_{qbt} \leq {Q}_{q}^{U} ∀ q ∈ Q , b ∈ B , t ∈ T \qquad Eq . 2 t$$

$${X}_{n {n}^{′} t} ∈ \{ True , False \} ∀ ( n , {n}^{′} ) ∈ A , t ∈ T \qquad Eq . 2 u$$

$${T}_{bt} ∈ \{ True , False \} ∀ b ∈ B , t ∈ T \qquad Eq . 2 v$$

where the nomenclature of sets, parameters, and variables are provided in Tables 1-3 below, respectively.

TABLE 1
Nomenclature of Sets

| Sets | Element | Description |
|---|---|---|
| N = S ∪ B ∪ D | n | Tanks |
| A | (n, n′) | Physical flow connections between tanks |
| S | s | Supply tanks |
| B | b | Blending tanks (Pools) |
| D | d | Demand tanks |
| Q | q | Specifications of material properties |
| T | t | Time periods |
| R | r | Supply sustainability credits |
| R′ | r′ | Demand sustainability credits |
| A^{credit} | (r, r′) | Mapping between sustainability credits |
| M | (d, r′) | Compatibility between product at |
| | | demand tank d and credit r′ |
| C | c | Specifications of sustainability credits |

TABLE 2
Nomenclature of Parameters

| Parameters | Sets | Description |
|---|---|---|
| ${I}_{n}^{0}$ | n ∈ N | Initial material inventory for tank n |
| ${Q}_{q b}^{0}$ | q ∈ Q, b ∈ B | Initial value for specification q at tank b |
| ${Q}_{qs}^{IN}$ | q ∈ Q, S ∈ S | Specification q in supply flow to tank s |
| $[ {D}_{dt}^{L} , {D}_{d t}^{U} ]$ | d ∈ D, t ∈ T | Bounds on finished product volume from tank d at time t |
| $[ {Q}_{qd}^{L} , {Q}_{q d}^{U} ]$ | d ∈ D | Bounds on specification q of finished product from tank d |
| $[ {I}_{n}^{L} , {I}_{n}^{U} ]$ | n ∈ N | Bounds on material inventory for tank n |
| $[ {F}_{{nn}^{′}}^{L} , {F}_{{nn}^{′}}^{U} ]$ | (n, n′) ∈ A | Bounds on physical flow between tank n and n′ |
| ${I}_{r}^{0}$ | r ∈ R | Initial inventory for sustainability credit r |
| ${C}_{cr}^{IN}$ | c ∈ C, r ∈ R | Specification c of sustainability credit r |
| Rₛ | s ∈ S | Sustainability credit associated with supply tank s |
| β_{dt} | d ∈ D, t ∈ T | Price for product at demand tank d and time t |
| β_{syt} | s ∈ S, γ ∈ R, | Price for material at supply tank s with credit γ and time t |
| | t ∈ T | |
| γ_{r′t} | (r′, R′)t ∈ T | Price for sustainability credit r′ at time t |
| α_{nn′} | (n, n′) ∈ A | Fixed cost for sending flow over arc (n, n′) |
| δ_{nn′} | (n, n′) ∈ A | Variable cost for sending flow over arc (n, n′) |
| nₙ | n ∈ N | Inventory cost at tank n |

TABLE 3
Nomenclature of Variables

| Variables | Sets | Description |
|---|---|---|
| Continuous | | |
| F_{nn′t} | (n, n′) ∈ A, t ∈ T | Physical flow between tanks n and n′ at time t |
| Sₛₜ | s ∈ S, t ∈ T | Supply flow to tank s at time t |
| D_{dt} | d ∈ D, t ∈ T | Demand flow from tank d at time t |
| Iₙₜ | n ∈ N, s ∈ S | Material inventory in tank n at time t |
| Q_{qbt} | q ∈ Q, b ∈ B, t ∈ T | Specification q in blending tank b at time t |
| Iᵣₜ | r ∈ R, t ∈ T | Credit inventory for credit r at time t |
| F_{rr′t} | r ∈ R, r′ ∈ R′, t ∈ T | Credit flow between credits r and r′ at time t |
| Sᵣₜ | r ∈ R, t ∈ T | Supply credit r at time t |
| D_{r′t} | r′ ∈ R′, t ∈ T | Demand credit from credit r′ at time t |
| D_{dr′t} | d ∈ D, r′ ∈ R′, t ∈ T | Demand credit r′ allocated to tank d at time t |
| C_{cr′t} | c ∈ C, r ∈ R, t ∈ T | Specification c of credit r′ at time t |
| Boolean | | |
| X_{nn′t} | (n, n′) ∈ A, t ∈ T | Existence of flow between tank n and n′ |
| Y_{bt} | b ∈ B, t ∈ T | Operating mode of blending tank b at time t |
| | | Y_{bt} = True implies it is charging |
| | | Y_{bt} = False implies it is discharging |

The objective function described in Equation 1a includes four parts: i) the revenue obtained from selling finished products and associated sustainability credits; ii) the cost for purchasing raw materials that come with sustainability credits; iii) the fixed and variable costs for sending physical flow over network; and iv) the inventory cost for storing materials and products. Depending on the application, some of the revenue or cost can be zero. In various embodiments, revenue is defined as the sum of the two revenues obtained from the selling of finished products and sustainability credits, denoted by β_{dt}D_{dt} and γ_{r′ t}D_{r′ t}, respectively. This separate accounting is because the same finished product can be sold with potentially different sustainability credits attached to the finished product. Also, as in the case of RINs the sustainability credits can be completely detached from finished products and be sold independently. In contrast, a single term is used for representing the cost for purchasing raw materials, denoted by β_{sγt}S_{sγt}. Without loss of generality, it may be assumed that the cost coefficient β_{sγt} represents the combined price for the raw material in supply tank s at time t and its associated sustainability credit γ.

In the feasible region of the problem described in Equations 1b-1v, there is a separation between sustainability credits allocation and physical blending: i) Equations 1b-1i are for modeling sustainability credits; and ii) Equations 1j-1v are for formulating the actual physical blending of raw materials. Equations 1j-1v correspond to the existing P-formulation for multiperiod pooling problems, except for the fact that we assume supply flows are variables, denoted by S_{sγt}, whereas they are parameters in existing formulations. The coupling between physical blending and sustainability credits occurs in Equations 1c and 1g by following the mass balance approach. Constraints are described mainly for sustainability credits. However, in various embodiments, the constraints may be similarly applied for any other types of digital credits. Physical blending constraints are represented in Equations 1j-1v. Raw materials in supply tanks come with supply sustainability credits. In some embodiments, for non-sustainable raw materials like crude-oil that do not have sustainability credits, an arbitrary credit of zero value may be assigned for accounting.

Equation 1c computes the mass balance of purchased supply sustainability credit r∈R at time t, which is equal to the sum of the masses of associated raw materials purchased. The virtual inventory levels of supply sustainability credits are managed by Equation 1b. No physical tank is needed to store credits, hence the use of virtual in virtual inventory. Supply sustainability credits are then detached from their corresponding raw materials once we account for their masses. Variable F_{rr′ t} represents the allocation of supply sustainability credit r to demand sustainability credit r′ at time t. The masses of such allocation should match with those of demand sustainability credits, as described in 2e. The allocation of demand sustainability credit r′∈R′ to finished product in demand tank d at time t is captured in variable D_{dr′ t}, and the masses of such allocation should be consistent with those of associated finished products and demand sustainabilities, described in Equations 2f and 2g, respectively. The demand sustainability credits can be allocated to their compatible finished products only, and the compatibility is represented by the notation d˜r′. Sustainability credits may have properties, such as GHG savings characteristics, and they can be blended in a similar way to physical blending, as described in Section 2.1 and formulated in Equation 2h. Like physical property criteria, demand sustainability credits may have property criteria as represented in Equation 2i. The mass balance rule for sustainability credits is preserved in the above formulation through Equations 2c-2g. In various embodiments, at the outset of the blending process, the composition of sustainable and non-sustainable raw materials is calculated using Equation 2c. Each finished product is assigned to some demand sustainability credits via Equation 2g. The masses of these demand sustainability credits should be consistent with those of supply sustainability credits via Equations 2e-2f. Therefore, the composition of sustainable and non-sustainable materials in finished physical products 116 is the same as that of raw materials in the physical feed 106A.

Those skilled in the art will appreciate that the exemplary system 100 of FIG. 1 is susceptible to modification without altering the technical effect provided by the present techniques. In practice, the exact manner in which the system 100 is implemented will depend, at least in part, on the details of the specific implementation. For example, in some embodiments, some of the blocks shown in FIG. 1 may be altered or omitted from the system 100 and/or new blocks may be added to the system 100.

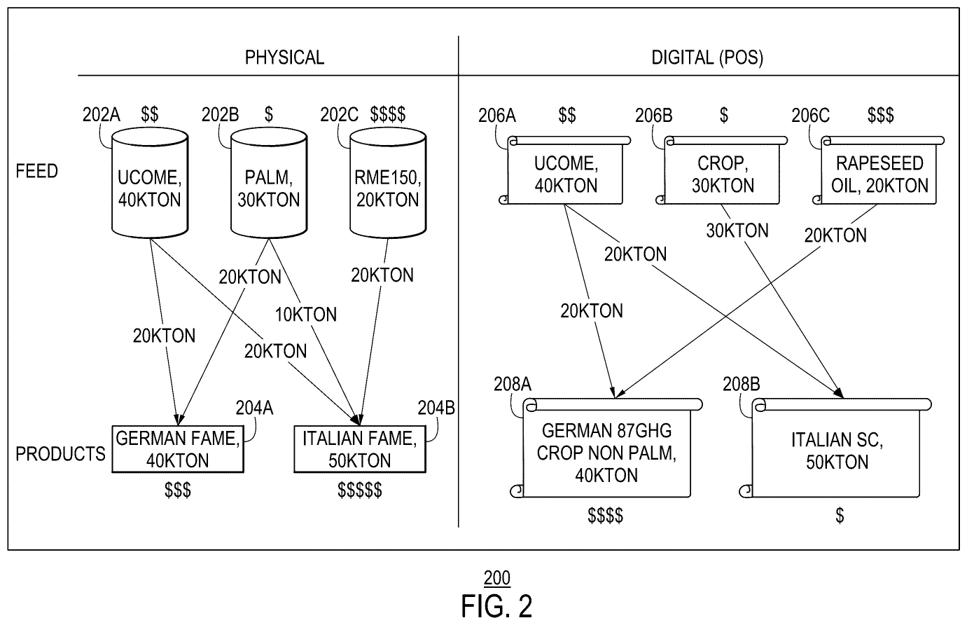

FIG. 2 is a diagram depicting an example separated blending 200 of a physical feed and associated digital feed to produce physical and digital products, in accordance with the present techniques. In various aspects, the blending may be executed using the method 300 described in FIG. 3. As shown in FIG. 2, a set of physical feeds 202A, 202B, 202C include 40 kilotons (KTON) of Used Cooking Oil Methyl Ester (UCOME), 30 KTON of PALM, and 20 KTON of RME150, respectively. For example, the UCOME feed 202A may be a type of biodiesel that is made from used cooking oil. The PALM feed 202B may include palm oil, also sometimes referred to as palm kernel oil. The RME150 feed 202C may include biodiesel including rape seed oil derived methyl esters (RMEs). The physical feeds 202A, 202B, and 202C are combined to produce physical products 204A and 204B. For example, physical product 204A is GERMAN FAME, which includes Fatty Acid Methyl Ester (FAME) with German regulation specifications. Physical product 204B is ITALIAN FAME, which includes FAME with Italian regulation specifications. Relative costs and profits are indicated using dollar signs.

The digital feeds 206A, 206B, and 206C include proof of sustainability (POS) credits of 40 KTON OF UCOME, 30 KTON OF CROP, and 20 KTON OF RAPESEED OIL, respectively. The digital feeds 206A, 206B, and 206C are combined used techniques described herein to generate digital products 208A and 208B. In the example of FIG. 2, the digital product 208A is 40 KTON of GERMAN 87 Green House Gas (GHG) CROP NON PALM and digital product 208B is 50 KTON of ITALIAN SC.

As demonstrated in the products of FIG. 2, supply credits 206A, 206B, and 206C can be detached from raw materials of physical feeds 202A, 202B, and 202C and used to generate demand credits of finished products 208A and 208B that are not directly related to the raw materials used to produce them. For example, although RME150 202C is not blended to produce GERMAN FAME product 204A, its RAPESEED OIL credit 206C is used to produce GERMAN 87GHG CROP NON PALM demand sustainability credit 208A, which can then be attached to the RME150 product 202C. In addition, supply credits 206A, 206B, 206C can be blended to produce demand credits that satisfy specific GHG emissions savings. For example, GERMAN 87GHG CROP NON PALM 208A requires that no palm oil be used in the blend. By blending RAPESEED OIL supply credit 206C with UCOME supply credit 206A, a credit 208A without any palm oil is generated in the same amount of 40 KTON as the GERMAN FAME physical product 204A.

Moreover, as demonstrated using dollar signs, in various embodiments, a low value PoS may be attached to a high value physical material, enabling a disconnect between the physical and PoS prices. Combining the optimization of both physical and digital products enables improved value over optimizing each separately or only optimizing the physical products while treating the POS as a constraint.

The example blending 200 of FIG. 2 is merely for purposes of illustration. In one or some embodiments, depending on input feed and target products, various different blends may be used instead. The number of input raw materials or target products may also differ. In various embodiments, any number of additional sets of intermediate blending layers may also be included.

FIG. 3 is a flow diagram of an exemplary method for multiperiod blending that includes digital constraints, in accordance with the present techniques. The example method 300 of FIG. 3 outlines an example workflow to allocate physical feeds. The method 300 may begin at block 302, where a physical feed, digital feed, and digital credits are received. For example, the physical feed may include various raw materials, such as biodiesels. The digital feed may include various supply credits associated with the various raw materials. In various embodiments, the digital credits may include demand credits.

At block 304, an optimal allocation of both the physical and digital feeds is jointly calculated to maximize a value of both physical and digital products. In various embodiments, the digital products may be demand credits. For example, the optimal allocation may be calculated using a pooling problem formulated as a mixed integer nonlinear programming problem (MINLP) or as a generalized disjunctive programming (GDP) formulation. In various embodiments, supply credits associated with raw materials are also combined to generate demand credits that have a maximum value when combined with the value of the physical products.

At block 306, a physical feed allocation is adjusted in a plant based on the maximized value to generate a physical product. For example, the physical feed allocation may be adjusted using a valve in the plant. In some embodiments, the physical product may be a biodiesel blend.

Those skilled in the art will appreciate that the exemplary method 300 of FIG. 3 is susceptible to modification without altering the technical effect provided by the present techniques. In practice, the exact manner in which the method 300 is implemented will depend, at least in part, on the details of the specific implementation. For example, in some embodiments, some of the blocks shown in FIG. 3 may be altered or omitted from the method 300 and/or new blocks may be added to the method 300. For example, the method 300 is an iterative process, in which initial maximized values are refined through successive approximations at blocks 302 and 304 and with updated physical changes at repeated block 306. In some embodiments, techniques such as discretization and linearization may also used to simplify the problem and find feasible solutions more efficiently.

### Exemplary Cluster Computing System for Implementing Present Techniques

FIG. 4 is a block diagram of an exemplary cluster computing system 400 that may be utilized to implement the present techniques. The exemplary cluster computing system 400 shown in FIG. 4 has four computing units 402A, 402B, 402C, and 402D, each of which may perform calculations for a portion of the present techniques. However, one of ordinary skill in the art will recognize that the cluster computing system 400 is not limited to this configuration, as any number of computing configurations may be selected. For example, a smaller analysis may be run on a single computing unit, such as a workstation, while a large calculation may be run on a cluster computing system 400 having tens, hundreds, thousands, or even more computing units.

The cluster computing system 400 may be accessed from any number of client systems 404A and 404B over a network 406, for example, through a high-speed network interface 408. The computing units 402A to 402D may also function as client systems, providing both local computing support and access to the wider cluster computing system 400.

The network 406 may include a local area network (LAN), a wide area network (WAN), the Internet, or any combinations thereof. Each client system 404A and 404B may include one or more non-transitory, computer-readable storage media for storing the operating code and program instructions that are used to implement the present techniques. For example, each client system 404A and 404B may include a memory device 410A and 410B, which may include random access memory (RAM), read only memory (ROM), and the like. Each client system 404A and 404B may also include a storage device 412A and 412B, which may include any number of hard drives, optical drives, flash drives, or the like.

The high-speed network interface 408 may be coupled to one or more buses in the cluster computing system 400, such as a communications bus 414. The communication bus 414 may be used to communicate instructions and data from the high-speed network interface 408 to a cluster storage system 416 and to each of the computing units 402A to 402D in the cluster computing system 400. The communications bus 414 may also be used for communications among the computing units 402A to 402D and the cluster storage system 416. In addition to the communications bus 414, a high-speed bus 418 can be present to increase the communications rate between the computing units 402A to 402D and/or the cluster storage system 416.

The cluster storage system 416 can have one or more non-transitory, computer-readable storage media, such as storage arrays 420A, 420B, 420C and 420D for the storage of models, data (including core data relating to one or more wells), visual representations, results (such as graphs, charts, and the like used to convey results obtained using the present techniques), code, and other information concerning the implementation of the present techniques. The storage arrays 420A to 420D may include any combinations of hard drives, optical drives, flash drives, or the like.

Each computing unit 402A to 402D can have a processor 422A, 422B, 422C and 422D and associated local non-transitory, computer-readable storage media, such as a memory device 424A, 424B, 424C and 424D and a storage device 426A, 426B, 426C and 426D. Each processor 422A to 422D may be a multiple core unit, such as a multiple core central processing unit (CPU) or a graphics processing unit (GPU). Each memory device 424A to 424D may include ROM and/or RAM used to store program instructions for directing the corresponding processor 422A to 422D to implement the present techniques. Each storage device 426A to 426D may include one or more hard drives, optical drives, flash drives, or the like. In addition, each storage device 426A to 426D may be used to provide storage for models, intermediate results, data, images, or code associated with operations, including code used to implement the present techniques.

The present techniques are not limited to the architecture or unit configuration illustrated in FIG. 4. For example, any suitable processor-based device may be utilized for implementing all or a portion of embodiments of the present techniques, including without limitation personal computers, laptop computers, computer workstations, mobile devices, and multi-processor servers or workstations with (or without) shared memory. Moreover, embodiments may be implemented on application specific integrated circuits (ASICs) or very-large-scale integrated (VLSI) circuits. In fact, persons of ordinary skill in the art may utilize any number of suitable structures capable of executing logical operations according to embodiments described herein.

FIG. 5 is a block diagram of an exemplary non-transitory, computer-readable storage medium 500 that may be used for the storage of data and modules of program instructions for implementing the present techniques. The non-transitory, computer-readable storage medium 500 may include a memory device, a hard disk, and/or any number of other devices, as described herein. A processor 502 may access the non-transitory, computer-readable storage medium 500 over a bus or network 504. While the non-transitory, computer-readable storage medium 500 may include any number of modules (and sub-modules) for implementing the present techniques, in some embodiments, the non-transitory, computer-readable storage medium 500 includes a multiperiod physical and digital blending module 506. More specifically, the multiperiod physical and digital blending module 506 may direct the processor 502 to allocate physical and digital feeds. For example, in various embodiments, the multiperiod physical and digital blending module 506 may direct the processor 502 to receiving a physical feed, digital feed, and physical and digital targets. The multiperiod physical and digital blending module 506 may direct the processor 502 to jointly calculate an optimal allocation of both the physical and digital feeds to maximize a value of both physical and digital products. The multiperiod physical and digital blending module 506 may direct the processor 502 to adjust a physical feed allocation in a plant based on the maximized value to generate a physical product.

In this manner, the techniques described herein provide a practical application that directly improves the allocation of physical resources, such as those used in biofuel production applications.

Although embodiments herein are described with respect to biofuel blending, one with skilled in the art will readily recognize that the techniques described herein are also suitable for application in other areas, such as water treatment, coal, and other raw material supply industries. For example, such applications may include wastewater treatment, coal blending to produce coals with various properties, and metal blending to produce metals with various properties. Other applications may include various raw material supply production, such as copper, cobalt, lithium, etc. For example, any of these raw materials may eventually come with a carbon intensity or sustainability credit that influences how the feedstocks are assigned to final product.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

### Embodiments of Present Techniques

In one or more embodiments, the present techniques may be susceptible to various modifications and alternative forms, such as the following embodiments as noted in paragraphs 1 to 20:

1. A method for allocating physical feeds, the method including receiving a physical feed, digital feed, and digital credits. The method includes jointly calculating an optimal allocation of both the physical and digital feeds to maximize a value of both physical and digital products. The method includes adjusting a physical feed allocation in a plant based on the maximized value to generate a finished physical product.
2. The method of paragraph 1, wherein supply credits are used to generate demand credits of the finished physical product that are not directly related to raw materials used to produce the finished physical product.
3. The method of paragraphs 1 or 2, wherein the physical product satisfies a received product specification constraint.
4. The method of any of paragraphs 1 to 3, wherein the digital credits include supply credits.
5. The method of any of paragraphs 1 to 4, wherein the digital credits include demand credits.
6. The method of any of paragraphs 1 to 5, wherein jointly calculating an optimal allocation of both the physical and digital feeds includes selecting a set of raw materials for blending.
7. The method of any of paragraphs 1 to 6, including allocating the digital feed to meet sustainability requirements at multiple nodes over a specified time horizon.
8. The method of any of paragraphs 1 to 7, wherein the digital credit includes supply credits that are blended to produce demand credits that satisfy a specific digital restriction.
9. The method of paragraph 8, wherein the specific digital restriction includes a minimum emissions savings.
10. The method of paragraph 8, wherein the specific digital restriction includes a ban on the use of a specific type of raw material.
11. The method of paragraph 8, wherein the specific digital restriction includes a use of a specific percentage of specific type of raw material.
12. The method of any of paragraphs 1 to 11, wherein the physical feed includes different biofuels.
13. The method of paragraph 12, wherein the physical product includes a biofuel blend.
14. The method of any of paragraphs 1 to 13, wherein the physical feed includes wastewater.
15. The method of any of paragraphs 1 to 14, wherein the physical feed includes coal.
16. The method of any of paragraphs 1 to 15, wherein the physical feed includes a metal.
17. The method of any of paragraphs 1 to 16, wherein a pooling problem for the optimal allocation is formulated as a generalized disjunctive programming (GDP) formulation.
18. The method of any of paragraphs 1 to 17, wherein a pooling problem for the optimal allocation is formulated as a mixed integer nonlinear programming problem (MINLP).
19. The method of any of paragraphs 1 to 18, wherein a pooling problem for the optimal allocation is solved using a genetic algorithm.
20. The method of any of paragraphs 1 to 19, wherein a pooling problem for the optimal allocation is solved using an evolutionary algorithm.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A method for allocating physical feeds, the method comprising:
receiving a physical feed, digital feed, and digital credits;
jointly calculating an optimal allocation of both the physical and digital feeds to maximize a value of both physical and digital products; and
adjusting a physical feed allocation in a plant based on the maximized value to generate a finished physical product.

2. The method of claim 1, wherein supply credits are used to generate demand credits of the finished physical product that are not directly related to raw materials used to produce the finished physical product.

3. The method of claim 1, wherein the physical product satisfies a received product specification constraint.

4. The method of claim 1, wherein the digital credits comprise supply credits.

5. The method of claim 1, wherein the digital credits comprise demand credits.

6. The method of claim 1, wherein jointly calculating an optimal allocation of both the physical and digital feeds comprises selecting a set of raw materials for blending.

7. The method of claim 1, comprising allocating the digital feed to meet sustainability requirements at multiple nodes over a specified time horizon.

8. The method of claim 1, wherein the digital credit comprises supply credits that are blended to produce demand credits that satisfy a specific digital restriction.

9. The method of claim 8, wherein the specific digital restriction comprises a minimum emissions savings.

10. The method of claim 8, wherein the specific digital restriction comprises a ban on the use of a specific type of raw material.

11. The method of claim 8, wherein the specific digital restriction comprises a use of a specific percentage of specific type of raw material.

12. The method of claim 1, wherein the physical feed comprises different biofuels.

13. The method of claim 12, wherein the physical product comprises a biofuel blend.

14. The method of claim 1, wherein the physical feed comprises wastewater.

15. The method of claim 1, wherein the physical feed comprises coal.

16. The method of claim 1, wherein the physical feed comprises a metal.

17. The method of claim 1, wherein a pooling problem for the optimal allocation is formulated as a generalized disjunctive programming (GDP) formulation.

18. The method of claim 1, wherein a pooling problem for the optimal allocation is formulated as a mixed integer nonlinear programming problem (MINLP).

19. The method of claim 1, wherein a pooling problem for the optimal allocation is solved using a genetic algorithm.

20. The method of claim 1, wherein a pooling problem for the optimal allocation is solved using an evolutionary algorithm.
